(19) United States
(12) Patent Application Publication
(10) Pub. No.: US 2026/0356182 A1
(43) Pub. Date: Nov. 12, 2026

(54) VEHICLE SUBFRAME

(71) Applicant: Hyundai Steel Company, Incheon (KR)

(72) Inventors: Chi Sung Jeon, Incheon (KR); Dong Yul Lee, Incheon (KR); Dong Hyun Kim, Incheon (KR)

(73) Assignee: Hyundai Steel Company, Incheon (KR)

(21) Appl. No.: 19/718,781

(22) Filed: Jun. 24, 2026

Related U.S. Application Data
(63) Continuation of application No. PCT/KR2024/021038, filed on Dec. 24, 2024.

(30) Foreign Application Priority Data
Dec. 29, 2023 (KR) 1020230197459

(51) Int. Cl. B60K 1/04; B62D 21/03; B62D 29/00

(52) U.S. Cl. CPC B60K 1/04; B62D 21/03; B62D 29/007

(57) ABSTRACT

Provided is a vehicle subframe including a first side member extending in a longitudinal direction of a vehicle, a second side member extending in the longitudinal direction of the vehicle and spaced apart from the first side member in a transverse direction of the vehicle, a first cross member extending in the transverse direction of the vehicle and connected to the first side member and the second side member, and a second cross member extending in the transverse direction of the vehicle, spaced apart from the first cross member in the longitudinal direction of the vehicle, and located closer to a front of the vehicle than the first cross member, in which a length of the first cross member in the vertical direction of the vehicle is greater than a length of the second cross member in the vertical direction of the vehicle.

### CROSS-REFERENCE TO THE RELATED APPLICATIONS

This application is a continuation of International Application No. PCT/KR2024/021038 filed Dec. 24, 2024, which claims the benefit of Korean Patent Application No. 10-2023-0197459, filed Dec. 29, 2023, in the Korean Intellectual Property Office, the entire contents of all of which applications are incorporated herein by reference.

### FIELD

In one aspect, embodiments of the present disclosure relate to a vehicle subframe.

### BACKGROUND

With the electrification of vehicles, the adoption of electric vehicles using electric motors as their power source instead of internal combustion engines is on the rise.

To increase their driving range (the distance that may be traveled on a full charge), the electric vehicles need to be equipped with high-capacity batteries. Typically, in such electric vehicles, an underside of a vehicle may be used as a space to mount the battery thereon. The battery may be mounted over a large area on the underside of the vehicle to increase the capacity of the battery, thereby extending the driving range.

As the battery is mounted on the underside of the vehicle, research is actively underway on the deformation of a vehicle body and a chassis in a front portion of the vehicle in the event of a frontal collision, offset collision, or small overlap collision. Also, safety measures have to be taken to protect the battery against impacts from protruding obstacles, such as speed bumps and uneven road surfaces.

### SUMMARY

In one aspect, embodiments of the present disclosure provide a vehicle subframe.

According to an aspect of the present disclosure, a vehicle subframe includes a first side member extending in a longitudinal direction of a vehicle, a second side member extending in the longitudinal direction of the vehicle and spaced apart from the first side member in a transverse direction of the vehicle, a first cross member extending in the transverse direction of the vehicle and connected to the first side member and the second side member, and a second cross member extending in the transverse direction of the vehicle, spaced apart from the first cross member in the longitudinal direction of the vehicle, and located closer to a front of the vehicle than the first cross member, in which a length of the first cross member in the vertical direction of the vehicle is greater than a length of the second cross member in the vertical direction of the vehicle.

According to the current embodiment, the first cross member may be arranged further toward a lower side of the vehicle than the second cross member.

According to the current embodiment, the first cross member may cover a front portion of a battery case arranged on a rear portion of the first cross member when viewed from a front of the vehicle.

According to the current embodiment, the first cross member suitably may have a straight shape, or substantially straight shape.

According to an embodiment, at least a portion of the first cross member suitably may have a curved shape protruding toward the front of the vehicle. For example, the first cross member may comprise a curved shape whose longitudinal axis forms an arc of a circle toward the front of the vehicle.

According to an embodiment, the first side member, the second side member, the first cross member, and/or the second cross member may include a cold-rolled steel material.

According to an embodiment, a tensile strength of a material included in the first side member, the second side member, the first cross member, and/or the second cross member suitably may be 440 MPa or greater.

According to the current embodiment, a tensile strength of a material included in the first side member, the second side member, the first cross member, and the second cross member may be 1,000 MPa or greater, but not greater than 2,000 MPa.

In additional aspects, a vehicle subframe system is provided that comprises a vehicle subframe as disclosed herein and an associated vehicle battery (such as a battery of an electric-powered vehicle). The battery may be contained with and/or within the subframe as disclosed herein.

In further aspects, a vehicle is provided that comprises a vehicle subframe as disclosed herein. A battery may be associated with the vehicle subframe. In aspects, an electric-powered vehicle (electric vehicle) is provided that comprises a vehicle subframe as disclosed herein. A battery may be associated with the vehicle subframe.

As referred to herein, tensile strength (TS) can be measured using a commercially available device such as a commercially available tensile tester and according to the ISO standard ISO 6892-1, published in October 2009.

According to an embodiment of the present disclosure as described above, it is possible to implement a vehicle subframe for protecting a battery of an electric vehicle. However, the scope of the present disclosure is not limited by these effects.

### BRIEF DESCRIPTION OF DRAWINGS

FIG. 1 shows a side view and a plan view schematically showing a vehicle.

FIG. 2A is a perspective view schematically showing a front body structure and a vehicle subframe of the vehicle.

FIG. 2B is a side view schematically showing a front body structure and a vehicle subframe of the vehicle, viewed from a side.

FIG. 2C is a plan view schematically showing a front body structure and a vehicle subframe of the vehicle, viewed from a front.

FIG. 3A is a perspective view schematically showing a vehicle subframe according to an embodiment.

FIG. 3B is a side view schematically showing a vehicle subframe according to an embodiment, viewed from a side.

FIG. 4 is a perspective view schematically showing a vehicle subframe according to an embodiment.

### DETAILED DESCRIPTION

The present disclosure may undergo various modifications and have various embodiments, and specific embodiments are illustrated in the drawings and described in detail in the detailed description. The effects and features of the present disclosure and the method for achieving them will become clear with reference to the embodiments described in detail below together with the drawings. However, the present disclosure is not limited to the embodiments disclosed below and may be implemented in various forms.

Hereinafter, embodiments of the present disclosure will be described in detail with reference to the accompanying drawings. In the drawings, identical or corresponding components are given the same reference numerals, and redundant descriptions thereof will be omitted.

In the embodiments below, the terms “first,” “second,” etc. are not used in a limiting sense but are used to distinguish one component from another.

In the embodiments below, an expression used in the singular encompasses the expression of the plural unless it has a clearly different meaning in the context.

In the embodiments below, the terms such as “including” and “having” are intended to indicate the existence of features or components disclosed in the specification and are not intended to preclude the possibility that at least one other feature or component may be added.

In the following embodiments, when a portion, such as a film, a region, a component, etc., is present on or above another portion, this case may include not only a case where it is directly on the other portion, but also a case where another film, region, component, etc., is arranged between the portion and the other portion.

In the drawings, the sizes of components may be exaggerated or reduced for convenience of description. For example, the sizes and thicknesses of each component in the drawings are arbitrarily illustrated for convenience of description, and therefore, the present disclosure is not necessarily limited to the drawings.

When it is possible to modify an embodiment, the order of processes may be different from the order in which the processes have been described. For example, two processes described as being performed sequentially may be substantially performed simultaneously or in a reverse order.

Herein, “A and/or B” may indicate A, B, or both A and B. “At least one of A and B” may indicate A, B, or both A and B.

In the following embodiments, when a film, a region, a component, etc., are connected, the case may include a case where they are directly connected, and/or a case where they are indirectly connected, having another film, region, and component therebetween. For example, herein, when a film, a region, a component, etc., are electrically connected, the case may include a case where they are directly electrically connected, and/or a case where they are indirectly electrically connected, having another film, region, and component therebetween.

An x-axis, a y-axis, and a z-axis are not limited to three axes on an orthogonal coordinate system, and may be interpreted in a broad sense including them. For example, the x-axis, y-axis, and z-axis may be orthogonal to one another or may indicate different directions that are not orthogonal to each other.

It is understood that the term “vehicle” or “vehicular” or other similar term as used herein is inclusive of motor vehicles in general such as passenger automobiles including sports utility vehicles (SUV), buses, trucks, various commercial vehicles, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In particular aspects, a vehicle as referred to herein includes an electri-powered vehicle.

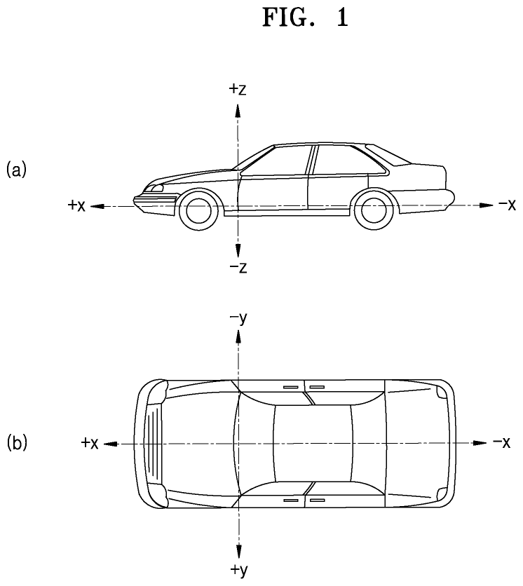

FIG. 1 shows a side view and a plan view schematically showing a vehicle. Specifically, FIG. 1 (a) is a side view schematically showing the vehicle viewed from a side, and FIG. 1 (b) is a plan view schematically showing the vehicle viewed from above. FIG. 1 is a side view and a plan view schematically showing the vehicle to specifically illustrate a longitudinal direction, a transverse direction, and a vertical direction of the vehicle.

Referring to FIG. 1 (a), the longitudinal direction of the vehicle may be an x-direction. The vertical direction of the vehicle may be a z-direction. The vertical direction of the vehicle (e.g., the z-direction) may intersect the longitudinal direction of the vehicle (e.g., the x-direction) as shown in the side view.

Referring to FIG. 1 (b), the longitudinal direction of the vehicle may be the x-direction. The transverse direction of the vehicle may be a y-direction. The transverse direction of the vehicle (e.g., the y-direction) may intersect the longitudinal direction of the vehicle (e.g., the x-direction). Although not shown, the vertical direction (e.g., the z-direction) of the vehicle may intersect the transverse direction (e.g., the y-direction) of the vehicle.

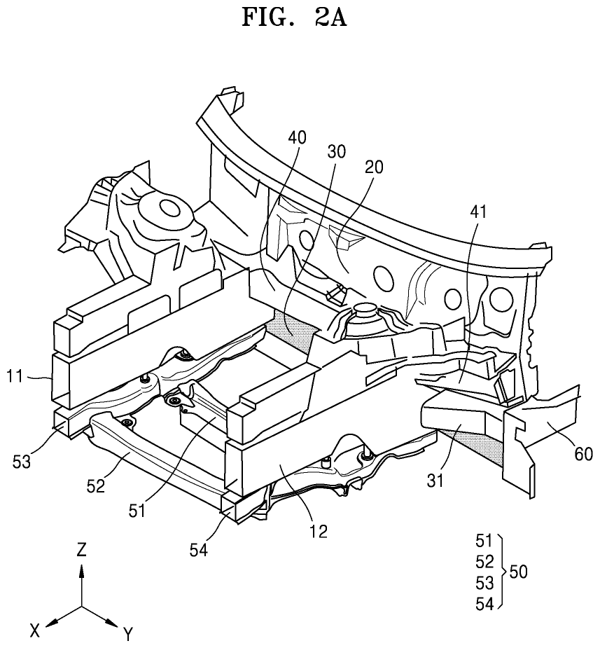

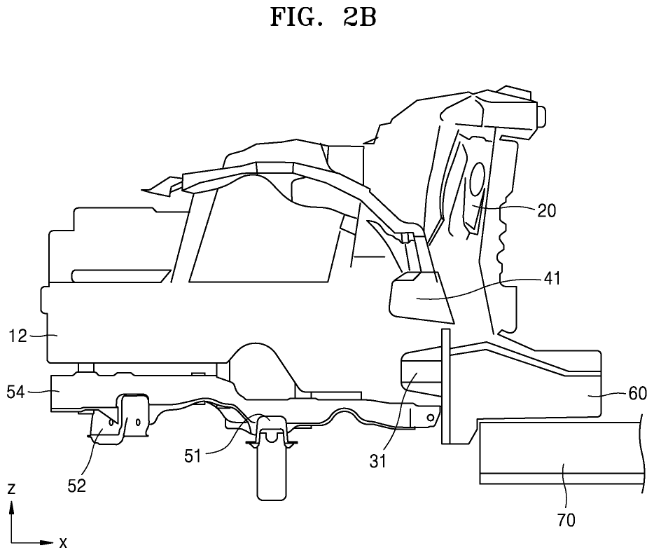

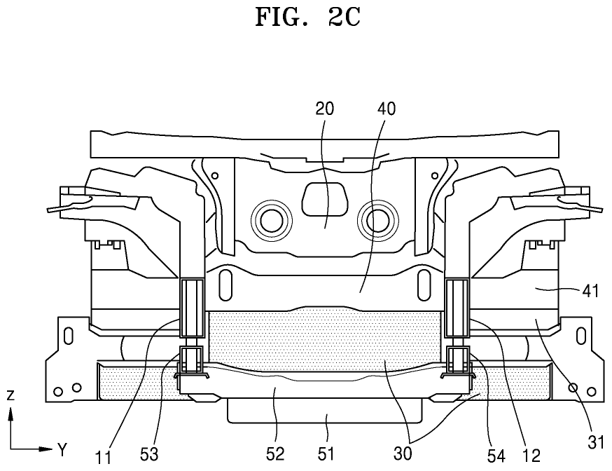

FIG. 2A is a perspective view schematically showing a front body structure and a vehicle subframe of the vehicle. FIG. 2B is a side view schematically showing a front body structure and a vehicle subframe of the vehicle, viewed from a side. FIG. 2C is a plan view schematically showing a front body structure and a vehicle subframe of the vehicle, viewed from a front.

Referring to FIGS. 2A, 2B, and 2C, the front body structure of the vehicle may include a first front side member 11, a second front side member 12, a rear cross member 30, a rear cross member side 31, a dash cross member 40, a dash cross member side 41, a dash panel 20, and a side sill inner front extension 60. The first front side member 11 and the second front side member 12 may be arranged to extend in the longitudinal direction (e.g., the x-direction) of the vehicle. The first front side member 11 and the second front side member 12 may be spaced apart from each other in the transverse direction (e.g., the y-direction) of the vehicle.

The rear cross member 30 may be connected to the first front side member 11 and the second front side member 12, and may extend in the transverse direction (e.g., the y-direction) of the vehicle.

The rear cross member 30 may include rear cross member sides 31 arranged on opposite sides thereof. In other words, the rear cross member 30 may include the rear cross member sides 31 arranged on the left and right sides of the vehicle. The first front side member 11 and the second front side member 12 may be connected to the rear cross member 30 and the rear cross member sides 31, and the first front side member 11 and the second front side member 12 may be connected to the side sill inner front extension 60 through the rear cross member sides 31.

The side sill inner front extension 60 may extend along the left and right sides of the vehicle in the longitudinal direction (e.g., the x-direction) of the vehicle. The side sill inner front extension 60 may be connected to the first front side member 11 and the second front side member 12 via the rear cross member sides 31. Although not shown, a side sill may be arranged on an outer side of the side sill inner front extension 60. A battery case 70 may be arranged below the side sill inner front extension 60.

A dash panel 20 may be arranged behind the first front side member 11 and the second front side member 12. In other words, a dash panel 20 may be arranged on the rear cross member 30 and the dash cross member 40. The length of the dash panel 20 may extend in the transverse direction (e.g., the y-direction) of the vehicle, and the height of the dash panel 20 may extend in the vertical direction (e.g., the z-direction) of the vehicle. The dash panel 20 may separate the front body structure of the vehicle from a passenger compartment of the vehicle. The front body structure of the vehicle may accommodate a powertrain that includes an electric motor or an internal combustion engine.

The dash cross member 40 may be arranged under the dash panel 20. The dash cross member 40 may extend in the transverse direction of the vehicle (for example, the y-direction). The dash cross member 40 may be connected to the dash panel 20.

The dash cross member sides 41 may be arranged on opposite sides of the dash cross member 40. In other words, the dash cross member sides 41 may be arranged on the left and right sides of the vehicle. The dash cross member sides 41 may be connected to the dash panel 20 and the dash cross member 40. The dash cross member sides 41 may be connected to the first front side member 11 and the second front side member 12.

In an embodiment, the vehicle subframe 50 may be arranged under the first front side member 11 and the second front side member 12. A specific structure of the vehicle subframe 50 will be described below.

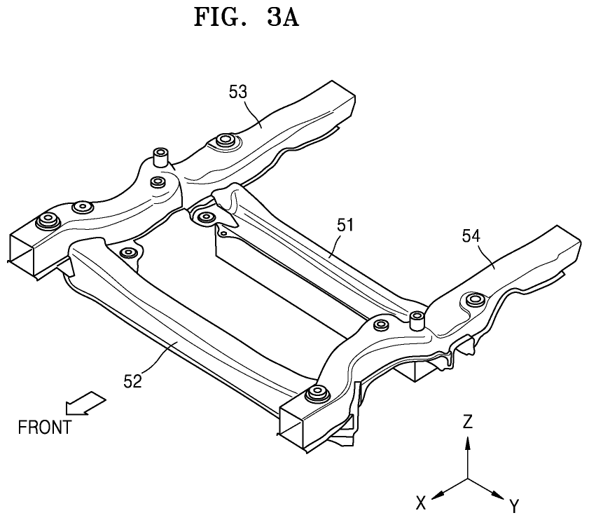

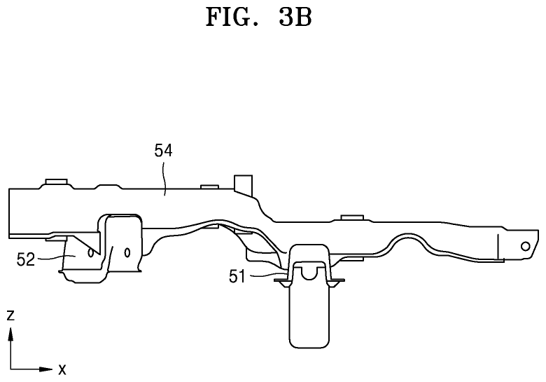

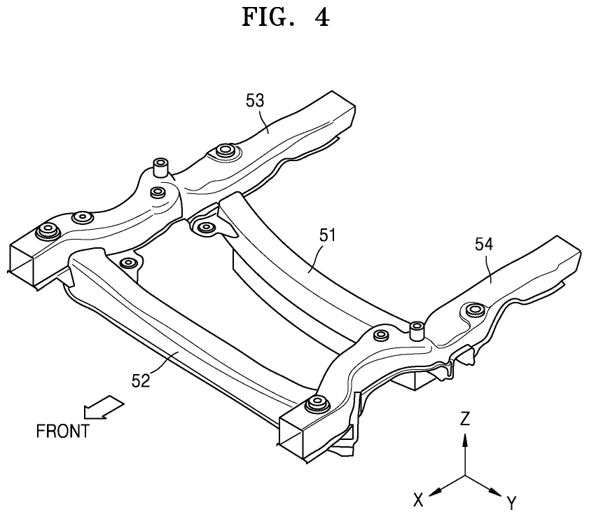

FIG. 3A is a perspective view schematically showing a vehicle subframe according to an embodiment. FIG. 3B is a side view schematically showing a vehicle subframe according to an embodiment, viewed from a side. FIG. 4 is a perspective view schematically showing a vehicle subframe according to an embodiment.

Referring to FIGS. 3A, 3B, and 4, the vehicle subframe 50 may include a first side member 53 and a second side member 54 extending in the longitudinal direction (e.g., the x-direction) of the vehicle. The first side member 53 and the second side member 54 may be spaced apart from each other in the transverse direction (e.g., the y-direction) of the vehicle.

The vehicle subframe 50 may include a first cross member 51 and a second cross member 52 extending in the transverse direction (e.g., the y-direction) of the vehicle. The first cross member 51 and the second cross member 52 may be spaced apart from each other in the longitudinal direction (e.g., the x-direction) of the vehicle.

The first cross member 51 may be connected to the first side member 53 and the second side member 54. Likewise, the second cross member 52 may be connected to the first side member 53 and the second side member 54. The second cross member 52 may be arranged closer to the front of the vehicle than the first cross member 51.

When viewed from the front of the vehicle, front surfaces of the first cross member 51 and the second cross member 52 may have a rectangular shape. However, the present disclosure is not limited thereto.

When viewed from a side of the vehicle, side surfaces of the first cross member 51 and the second cross member 52 may have a rectangular shape. However, the present disclosure is not limited thereto. When viewed from the side of the vehicle, the side surfaces of the first cross member 51 and the second cross member 52 may have a parallelogram or trapezoid shape.

In an embodiment, the length of the first cross member 51 in the vertical direction (e.g., the z-direction) of the vehicle may be greater than the length of the second cross member 52 in the vertical direction (e.g., the z-direction) of the vehicle. In other words, the first cross member 51 may be arranged further toward a lower side of the vehicle than the second cross member 52. When viewed from the front of the vehicle, the first cross member 51 may be provided to cover the front portion of the battery case 70 (see FIG. 1B). An end of the first cross member 51 positioned furthest toward the lower side of the vehicle and an end of the battery case 70 positioned furthest toward the lower side of the vehicle may be positioned at the same position in the vertical direction (e.g., the z-direction) of the vehicle, or the end of the first cross member 51 may be positioned further toward the lower side (e.g., a-z-direction) of the vehicle than the end of the battery case 70.

As the first cross member 51 is arranged further toward the lower side of the vehicle than the second cross member 52 and is provided to cover the front portion of the battery case 70 (see FIG. 1B) when viewed from the front of the vehicle, the first cross member 51 may contact an object before the battery case 70 when the object or a curb passes below the vehicle, causing the vehicle to come to a stop and preventing the battery case 70 and the battery arranged at the rear of the first cross member 51 from being damaged.

In an embodiment, the first cross member 51 may have a straight shape. However, the present disclosure is not limited thereto. In another embodiment, at least a portion of the first cross member 51 may have a curved shape. Specifically, at least a portion of the first cross member 51 may have a curved shape protruding toward the front of the vehicle. To be specific, a radius of curvature of the first cross member 51 in the curved shape may be 1,500 mm or greater.

When at least a portion of the first cross member 51 have a curved shape protruding toward the front of the vehicle, an object may collide with a forwardly protruding portion of the first cross member 51 when the object passes below the vehicle, allowing the vehicle to deviate leftward and rightward and the vehicle to come to a stop. In addition, the forwardly protruding portion of the first cross member 51 may absorb energy in the event of the collision with the object, thereby preventing the battery case 70 and the battery located on a rear portion of the first cross member 51 from being damaged.

A material used for the vehicle subframe 50 may be a plated or non-plated cold rolled steel. The tensile strength of the vehicle subframe 50 may be 440 MPa or greater. The vehicle subframe 50 may include heat-treated steel, and have a tensile strength of 1,000 MPa to 2,000 MPa.

According to an embodiment of the present disclosure, the first cross member 51 of the vehicle subframe 50 may have a length greater than that of the second cross member 52 in the vertical direction (e.g., the z-direction) of the vehicle. The first cross member 51 of the vehicle subframe 50 may cover the battery case 70, such that when the object passes below the vehicle, the first cross member 51 of the vehicle subframe 50 collides with the object before the battery case 70, causing the vehicle to come to a stop and to absorb energy in the event of the collision, thereby preventing the battery case 70 and the battery from being damaged.

Although the present disclosure has been described with reference to an example shown in the drawings, it will be understood by those of ordinary skill in the art that various modifications and equivalent other examples may be made from the shown example. Accordingly, the true technical scope of the present disclosure should be defined by the technical spirit of the appended claims.

1. A vehicle subframe comprising:
a) a first side member extending in a longitudinal direction of a vehicle;
b) a second side member extending in the longitudinal direction of the vehicle and spaced apart from the first side member in a transverse direction of the vehicle;
c) a first cross member extending in the transverse direction of the vehicle and connected to the first side member and the second side member; and
d) a second cross member extending in the transverse direction of the vehicle, spaced apart from the first cross member in the longitudinal direction of the vehicle, and located closer to a front of the vehicle than the first cross member,
wherein a length of the first cross member in the vertical direction of the vehicle is greater than a length of the second cross member in the vertical direction of the vehicle.

2. The vehicle subframe of claim 1, wherein the first cross member is arranged further toward a lower side of the vehicle than the second cross member.

3. The vehicle subframe of claim 1, wherein the first cross member covers a front portion of a battery case arranged rearward of the first cross member when viewed from a front of the vehicle.

4. The vehicle subframe of claim 1, wherein the first cross member has a straight shape.

5. The vehicle subframe of claim 1, wherein at least a portion of the first cross member has a curved shape protruding toward the front of the vehicle.

6. The vehicle subframe of claim 1, wherein the vehicle subframe comprises a cold-rolled steel material.

7. The vehicle subframe of claim 1, wherein a tensile strength of the vehicle subframe is 440 MPa or greater.

8. The vehicle subframe of claim 7, wherein a tensile strength of the vehicle subframe is 1,000 MPa or greater, but not greater than 2,000 MPa.

9. A vehicle subframe system comprising;
a) a vehicle subframe of claim 1; and
b) an associated vehicle battery.

10. A vehicle comprising a vehicle subframe of claim 1.

11. The vehicle of claim 10 wherein the vehicle is electric-powered.
